(19) United States
(12) Patent Application Publication
(10) Pub. No.: US 2016/0207252 A1
(43) Pub. Date: Jul. 21, 2016

(54) WELDING METHOD USING WELDING PROMOTERS

(71) Applicant: HENKEL AG & CO. KGAA, Duesseldorf (DE)

(72) Inventors: Pablo WALTER, Muenchen (DE); Martin RENKEL, Duesseldorf (DE); Christian HOLTGREWE, Duesseldorf (DE); Thomas BACHON, Duesseldorf (DE); Rainer SCHOENFELD, Duesseldorf (DE); Katherine M. HELMETAG, Troy, MI (US)

(21) Appl. No.: 15/056,162

(22) Filed: Feb. 29, 2016

Related U.S. Application Data
(63) Continuation of application No. PCT/EP2014/068408, filed on Aug. 29, 2014.
(60) Provisional application No. 61/872,004, filed on Aug. 30, 2013.

(51) Int. Cl. B29C 65/14; B29C 65/06; B29C 65/00; B29C 65/10; B29C 65/18; B29C 65/08; B29C 65/04

(52) U.S. Cl. CPC B29C 65/1483; B29C 65/08; B29C 65/06; B29C 65/04; B29C 65/10; B29C 65/1412; B29C 65/18; B29C 66/026

(57) ABSTRACT

The present invention relates to a method for forming a welded bond between polymer surfaces, comprising (i) applying a welding promoter composition to a to-be-welded area of one or both polymer surface(s), wherein the welding promoter composition comprises particles with a particle size range of 0.1 to 1000 μm, the particles being made of a material that is inert towards a chemical reaction with the first and/or second polymer surface; (ii) applying energy to the to-be-welded area of the first polymer surface, the second polymer surface or both, the energy being sufficient to melt at least a portion of the polymer in the to-be-welded area of the polymer surface, and contacting the to-be-welded areas of the polymer surfaces; and (iii) allowing the molten polymer in the to-be-welded area to solidify so that a welded bond is formed between the polymer surfaces. The invention further relates to the thus produced articles and the use of the described compositions as welding promoters.

### FIELD OF INVENTION

The present invention relates to a method for the welding of plastics using welding promoters. The invention further relates to the thus produced articles and the use of the compositions described herein as welding promoters.

### BACKGROUND OF THE INVENTION

The joining of different materials using bolts, adhesives or welding techniques is well-established in the art. For example, for the production of an assembled product, it is often necessary to weld together two parts, in particular two parts made of polymers. Although suitable welding techniques, such as hot gas welding, hot plate welding, high frequency welding, ultrasonic welding, friction welding, and laser welding, are known, the design of the interface in a way that complex parts are weldable remains a challenge. This is due to the fact that all the afore-mentioned techniques have in common that they induce high amounts of energy or heat between the two parts that are to be joined. In order to direct the energy to the interface and avoid undefined melting of the parts, a specific design of the parts to be joined or more particularly their interface is necessary. The usually utilized special interface design shapes are called “energy directors”. For example, a rough surface or a surface with small protrusions is extremely good to weld, as a smaller contact area helps to focus the welding energy to the desired area. However, the need for this special surface designs entails a high complexity in the part design and production.

There is thus need in the art for methods that overcome the above drawbacks of existing technologies and allow welding of parts without having to adjust their shape or interface toward this joining technology. This would have the advantage that the time for part design in terms of weldable interface and injection molding process could be significantly reduced.

Although it is known in the art to use primers that activate or clean the surface to be joined or adhesives at the interface to make a better connection between the two parts that are to be joined, such uses do not overcome the part design issues, as they merely support joining two parts that have been designed for welding.

### BRIEF DESCRIPTION OF THE INVENTION

The present invention meets the above-formulated need for a welding process that allows welding of parts without having to adjust their shape or interface toward this joining technology by providing a method for welding two polymer surfaces not specifically adapted for welding that uses a welding promoter composition, with the welding promoter being inert towards chemical reaction with the surface polymer and not increasing the adhesion between the two to-be-joined surfaces. More specifically, it has surprisingly found by the inventors of the present invention that using chemically inert particles in form of powders, gels or dispersions as welding promoters obviates the need for surface structures that function as energy directors, as the particles can take over this function and direct the welding energy to concrete areas of the surface that are to be welded.

In a first aspect, the present invention thus relates to a method for forming a welded bond between a first and a second polymer surface, comprising:
(i) applying a welding promoter composition to a to-be-welded area of the first polymer surface, the second polymer surface or both, wherein the welding promoter composition comprises particles with a particle size range of 0.1 to 1000 μm, the particles being made of a material that is inert towards a chemical reaction with the first and/or second polymer surface;
(ii) applying energy to the to-be-welded area of the first polymer surface, the second polymer surface or both, the energy being sufficient to melt at least a portion of the polymer in the to-be-welded area of the first polymer surface, the second polymer surface or both, and contacting the to-be-welded areas of the first and second polymer surfaces together, wherein the step of applying energy can be performed before and/or during contacting the to-be-welded areas of the first and second polymer surfaces; and
(iii) allowing the molten polymer in the to-be-welded area of the first polymer surface, the second polymer surface or both to solidify so that a welded bond is formed between the first and the second polymer surface.

Another aspect of the invention relates to articles comprising a welded bond obtainable according to the above-described method.

In still another aspect, the present invention also encompasses the use of a composition comprising particles as a welding promoter to form a welded bond between two polymer surfaces, the particles being of a material that is inert towards a chemical reaction with the polymer surfaces and does not enhance adhesion between the first and second polymer surfaces, wherein the particles have a particle size range of 0.1 to 1000 μm.

### DETAILED DESCRIPTION OF THE INVENTION

In the following, the invention is described in greater detail. It is however understood that the present invention is not limited to the below embodiments, but can easily be adapted to use other polymers and particle materials. Such alternative embodiments are also encompassed by the scope of the instant invention.

In a first step of the method to form the welded bond, a welding promoter composition is applied to a to-be-welded area of the first polymer surface, the second polymer surface or both. The term “polymer surface,” as used in this connection, relates to a polymeric material that makes up the surfaces of the parts to be joined. Preferably, the parts consist of this polymer material, i.e. the polymer surface is the surface of a polymer body or part, for example a resin body. “Polymeric material” or “polymer material,” as used herein, relates to a polymer composition that may, in addition to the polymer, comprise additional components, such as fillers, additives and the like. The two polymers of the two surfaces that are to be joined or, in more specific embodiments, the material of the two bodies or parts to be joined, can be the same or different. If they are different, such different materials may have disparate melting temperature ranges which would complicate the welding process with existing methods, but is less problematic when employing the herein described methods. “Disparate melting temperature ranges,” as used herein, means that the two polymeric materials detectably differ in their melting temperature ranges.

The polymers making up the surfaces or the parts to be joined are preferably thermoplastic polymers. Although it is preferred that the polymers of both surfaces are thermoplastics, in certain embodiments either one of the two polymer surfaces may be made of a thermoplastic material, while the other one is made of a different polymer material, such as a thermoset polymer.

Suitable base polymers that can be welded together by the described methods include, without being limited thereto, polypropylene (PP), polyethylene (PE), polyoctene, poly(styrene-butadiene-styrene) (SBS), poly(styrene-isoprene-styrene) (SIS), poly(styrene-ethylene/butylene-styrene) (SEBS), poly(styrene-ethylene/propylene-styrene) (SEPS), poly ethylene-vinyl acetate (EVA), acrylonitril butadiene styrene (ABS), poly(methyl methacrylate) (PMMA), polymethacrylate, polyacrylate, polycarbonate (PC), polystyrene (PS), polyamide (PA), polyvinyl chloride (PVC), and copolymer and blends thereof. Suitable blends include, for example, PC/ABS blends and PA/ABS blends. In preferred embodiments, the polymer of the first surface is PP or PA and the polymer of the second surface is PA, PP, PC/ABS, ABS, PMMA, PA/ABS or PC. “Base polymer,” as used herein, means that the polymer is the main polymeric ingredient of a given polymer composition, i.e. >50 wt.-% of all polymers in the composition are the base polymer. The copolymers mentioned above include those where one monomeric unit or prepolymer is one of the above which is copolymerized with another monomeric unit or prepolymer.

The surfaces to be bonded can be flat or planar but also may be contoured.

The welding promoter composition can be in any form that allows for the presence of discrete particles of the given specification. Suitable forms include, without being limited thereto, powders, gels and dispersions. As the particles are usually in solid form, in case they are used in form of gels or dispersions they are dispersed in a suitable matrix. The matrix can be any suitable material and is preferably also inert towards a chemical reaction with the first and/or second polymer surface. More specifically, it is preferred that the welding promoter composition does not include any known primers, for example those that clean or activate the surface, or adhesives, for example those that chemically react with the surface polymers and form a chemical bond between the two surfaces usually after curing. It is preferred that the particles only function as an energy director, i.e. direct the welding energy to the areas to be welded and lead to at least partial melting of the polymer surface. It is further preferred that the particles and the welding composition do not enhance adhesion between the first and second polymer surfaces, i.e. do not have an adhesive effect.

“Inert,” as used herein, means that the thus designated material does, under welding conditions, not chemically react with the polymer of the surfaces to be joined during any of the steps of the method. “Chemically react,” as used herein, means that no covalent bonds are formed between the material of the welding composition, i.e. in particular the particles, and the polymer surfaces.

The application can, depending on the form of the welding promoter composition, be done by any existing technique suitable for this purpose. Suitable application techniques include, without limitation, printing, sprinkling, spray-coating, spin-coating, dip-coating and the like.

In various embodiments, the welding promoter composition is only applied to those areas of the surface that are to be welded. In such embodiments, it serves the purpose to direct the applied welding energy to these specific areas which upon the receiving the energy superficially melt so that undefined and uncontrolled melting of the polymer surface is avoided.

The welding promoter composition comprises particles, the particles being of a material that is inert towards a chemical reaction with the first and/or second polymer surface and does not enhance adhesion between the first and second polymer surfaces. The particles preferably have a specific density of 0.1 to 20 g/cm³, more preferably of about 1 to about 4 g/cm³. The bulk density may be in the range of 1 to 10 g/cm³. The size of the particles is in the range of 0.1 to 1000 μm, preferably 10 to 500 μm. “Size,” as used in this connection, relates to the extension along the greatest dimension of the particle. The particles can have any shape, but are preferably essentially spherical or cubic in shape. The particles can be essentially monodisperse or multidisperse. The mean size of the particles is preferably in the range of 1 to 1000, preferably 10 to 500, more preferably 50 to 400 μm. “Mean size” relates to the arithmetic mean size of the particles. Various techniques for determining particle sizes are known in the art. Those include by way of example only sieving techniques, dynamic light scattering and laser diffraction. Preferably, the particle size is determined by sieving techniques. The mean particle size is preferably determined by dynamic light scattering.

In various embodiments, the particles have a Mohs hardness of a least 2.5, preferably at least 3, more preferably at least 3.5, most preferably at least 4.

In various embodiments the particles comprise, consist essentially of or consist of an inorganic material, such as glass, silica, ceramics, metals, metal compounds and the like. The metal compounds include metal oxides, metal salts and reaction products of metals with non-metals, such as phosphides, nitrides and the like. Preferred inorganic materials include, but are not limited to silica, alumina, iron oxide, titanium oxide, magnesium oxide, ferric phosphide, and glass, such as soda-lime borosilicate glass. Also contemplated are mixtures of the afore-mentioned materials.

The particles may be microspheres that may optionally be hollow. “Microspheres” relates to spheric particles with a diameter in the μm range (1 to 1000 μm).

Suitable materials that can be used include, without being limited thereto, glass beads, preferably with a diameter of about 200 μm (Spheriglass, Potters Europe), Ferrophos 2132 (Occidental Chemical Corporation), Cenospheres S500 and Cab-o-Sil. For the selection of the material, it is useful if the material provides for an increased friction between the surfaces.

In the next step of the method described herein, energy is applied to the to-be-welded areas of the first and/or second polymer surface. The amount of energy is sufficient to at least partially melt the polymer at the surface of the area to be welded. The welding promoter composition, in particular the particles contained therein, serves the purpose to direct the welding energy to these specific areas and avoid an undefined and uncontrolled melting of the polymer surface.

To form the welded bond, the energy can first be applied to melt the polymer at the surface and after the melting has occurred the to-be-welded areas can be contacted together. Alternatively, both steps can be performed simultaneously, i.e. the energy is applied while the two areas are contacted together. The contacting can be pressing, i.e. the two surfaces are actively pressed together by application of force. In the contacting, especially in the pressing, the force applied can be varied over the course of time. The step of applying the energy can be repeated once or multiple times. For example, energy can be applied to one or both surface to induce melting, than the two surfaces are contacted and during and/or after this contacting again energy is applied.

The energy applied can be in form of heat, ultrasound, vibration, irradiation or friction. In other words, the surfaces to be joined may be heated, subjected to ultrasound or irradiation, in particular infrared or laser irradiation, or rubbed together. The aim of this treatment is to at least partially melt the polymer at the surface of the to-be-welded areas. Known techniques to introduce the energy into the system and lead to the melting of the polymer surface include, but are not limited to, hot gas welding, hot plate welding, high frequency welding, ultrasonic welding, friction welding and laser welding and also infrared welding. It can be preferable to use a combination of at least two energy sources, especially two. In one embodiment, infrared welding is combined with vibration welding or ultrasonic welding.

In a preferred embodiment, the energy is used in form of ultrasonic energy. Multiple different ultrasonic energy providers may be used to provide ultrasonic energy to the surfaces. A typical ultrasonic energy provider will be configured to provide ultrasonic energy and will include two or more of an energy source, e.g. a power supply or power generator, one or more energy processors, e.g. a converter, a booster or both, and an energy transmitter, e.g. a horn.

Once the polymer at the surface has at least partially melted, the two surfaces may be rubbed against each other to blend the melted polymers of the surfaces. This is particularly useful in case the two polymers are different polymers and both surfaces have at least partially melted.

In the final step of the described method, the melted polymers are allowed to solidify again so that welded bond is formed between the two surfaces. The solidification can occur by stopping the application of energy to the system and the thus induced cooling.

Those skilled in the art can use the method as described herein and vary the polymers of the bodies to be welded as well as the material of the particles used as energy directors, the form of the energy applied and the conditions, i.e. amount of welding promoter and energy applied, time of energy application, etc., such that they will arrive at bonded articles with those welded bonds which are required for the intended purpose.

The present invention also relates to the welded articles, i.e. the assembled products, obtained or obtainable by the described methods.

Also encompassed is the use of a composition comprising particles as defined above for forming a welded bond between two polymer surfaces. All limitations disclosed above in connection with the methods described herein are similarly applicable to the uses. This particularly relates to the definitions of the particles and welding promoter compositions and the to-be-joined polymer bodies.

### Example

Two polyamide (PA6.6; Latamid 66H2) polymer substrates in lap shear geometry of an overlap of +/−5mm were chosen. The substrates were welded by ultrasonic welding using a KLN ultrasound generator type 588 in combination with a sonotrode. A constant pressure perpendicular to the welded area in the range between 0.5-1.6 N/mm² was applied. Welding time was constantly held at 1 s.

Table 1 shows the results of the lap shear strength (LSS) experiments that were done with different particle materials as welding promoters to show the enhancement of the welding. In this experiment, LSS values of more than 5, preferably more than 10 indicate a good welding result. One benefit is to focus/direct the welding to the desired overlap area and the other benefit is to increase the LSS values by introducing a proper welded area. Particularly good results were obtained with glass beads, Ferrophos 2132 and Cenospheres S500.

TABLE 1
LSS experiments

| | | | Specific | | | |
|---|---|---|---|---|---|---|
| | | | Density/ | | | Welding |
| | | | Bulk | | | only in |
| # of | Welding | Size | Density | Mohs | LSS | overlap |
| Experiment | composition | [μm] | [g/cm³] | Hardness | [N/mm²] | area |
| 1 | Sea sand | <1000 | | 6-7 | 9.9 | Yes |
| 2 | 200 μm glass | 212 | 2.3-2.7/ | 4-7 | 20.4 | Yes |
| | beads | | | | | |
| 3 | Ferrophos 2132 | 5 | 6.53/ | 6.5-7 | 13.8 | Yes |
| | | | 2.34 | | | |
| 4 | Cenospheres | 30-75% | 0.6-0.9/ | 5-6 | 12.6 | Yes |
| | S500 | <150 | 0.33-0.47 | | | |
| 5 | Scotchlite VS | 90% 75 | 0.35/ | 5-6 | 6.7 | Yes |
| | 5500 | | 0.19-0.24 | | | |
| 6 | 4.5 wt.-% Miox | 98% 5 | 4.8/2.3 | 6.0-6.5 | 11.5 | Yes |
| | Sub-5 | <45 | | | | |
| | 4.5 wt.-% Cab- | | | | | |
| | o-Sil TS 720 | | | | | |
| | 91 wt.-% PPG | | | | | |
| | 200 | | | | | |
| 7 | 4.5 wt.-% Miox | | | | 5.1 | Yes |
| | Sub-5 | | | | | |
| | 2.3 wt.-% Cab- | | | | | |
| | o-Sil TS 720 | | | | | |
| | 92.9 wt.-% | | | | | |
| | Glycerin | | | | | |

1. A method for forming a welded bond between a first and a second polymer surface, comprising:
(i) applying a welding promoter composition to a to-be-welded area of the first polymer surface, the second polymer surface or both, wherein the welding promoter composition comprises particles with a particle size range of 0.1 to 1000 μm, the particles being made of a material that is inert towards a chemical reaction with the first and/or second polymer surface;
(ii) applying energy to the to-be-welded area of the first polymer surface, the second polymer surface or both, the energy being sufficient to melt at least a portion of the polymer in the to-be-welded area of the first polymer surface, the second polymer surface or both, and contacting the to-be-welded areas of the first and second polymer surfaces together, wherein the step of applying energy can be performed before and/or during contacting the to-be-welded areas of the first and second polymer surfaces together;
(iii) allowing the molten polymer in the to-be-welded area of the first polymer surface, the second polymer surface or both to solidify so that a welded bond is formed between the first and the second polymer surface.

2. The method of claim 1, wherein the first polymer surface and/or the second polymer surface are the surface(s) of a resin body.

3. The method of claim 1, wherein the polymer of the first polymer surface and the polymer of the second polymer surface are the same or different.

4. The method of claim 1, wherein the polymer of the first polymer surface and/or the polymer of the second polymer surface are thermoplastic resins.

5. The method of claim 1, wherein the base polymer of the first and/or second surface is independently selected from the group consisting of polypropylene (PP), polyethylene (PE), polyoctene, poly(styrene-butadiene-styrene) (SBS), poly(styrene-isoprene-styrene) (SIS), poly(styrene-ethylene/butylene-styrene) (SEBS), poly(styrene-ethylene/propylene-styrene) (SEPS), poly ethylene-vinyl acetate (EVA), acrylonitril butadiene styrene (ABS), poly(methyl methacrylate) (PMMA), poly(meth)acrylate, polycarbonate (PC), polystyrene (PS), polyamide (PA), polyvinyl chloride (PVC), and copolymer and blends thereof.

6. The method of claim 1, wherein the welding promoter composition is in form of a powder, a gel, or a dispersion.

7. The method of claim 1, wherein the particles have a Mohs hardness of at least 2.5, preferably at least 3, more preferably at least 4.

8. The method of claim 1, wherein the particles of the welding promoter composition comprise glass, metals, metal oxides, metal salts, silica,ceramics, and mixture thereof.

9. The method of claim 1, wherein the energy heat, vibration, ultrasonication, irradiation and/or friction.

10. The method of claim 9, wherein the step of applying energy includes hot gas welding, hot plate welding, high frequency welding, ultrasonic welding, friction welding, infrared welding and/or laser irradiation welding.

11. The method of claim 1, wherein method is free of a primer or an adhesive to form the welded bond between the first and the second polymer surface.

12. The method of claim 11, wherein the particles of the welding promoter composition function as energy directors to direct the energy applied to the to-be-welded areas of the first and/or second polymer surface.

13. An article comprising a welded bond obtained according to the method of claim 1.

14. A composition comprising particles as a welding promoter to form a welded bond between two polymer surfaces, the particles being of a material that is inert towards a chemical reaction with the polymer surfaces, wherein the particles have a particle size range of 0.1 to 1000 μm.

15. The composition of claim 14, wherein the particles of the composition comprise glass, metals, metal oxides, metal salts, silica, ceramics and mixture thereof;
wherein the particles have a Mohs hardness of at least 2.5.
